(19) United States
(12) Patent Application Publication
(10) Pub. No.: US 2009/0284447 A1
(43) Pub. Date: Nov. 19, 2009

(54) PLASMA DISPLAY APPARATUS

(75) Inventors: Haruo Koizumi, Miyazaki (JP); Makoto Onozawa, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: HITACHI PLASAMA DISPLAY LIMITED, Miyazaki (JP)

(21) Appl. No.: 12/306,528

(22) PCT Filed: Sep. 4, 2006
(86) PCT No.: PCT/JP2006/317916

§ 371 Date: Dec. 24, 2008

(51) Int. Cl. G09G 3/28

(52) U.S. Cl. 345/60

(57) ABSTRACT

An object of the present invention is to reduce power consumption and heat generation in an A/S separating circuit for preventing an inflow of an auxiliary voltage into a sustain discharge voltage source in a Y electrode driver circuit or an X electrode driver circuit of a plasma display apparatus. In the present invention, a sustain-voltage generating circuit in the Y-electrode driver circuit or the X-electrode driver circuit is configured of a bidirectional switch, and the A/S separating circuit is removed.

### TECHNICAL FIELD

The present invention relates to a plasma display apparatus (PDP apparatus). More particularly, the present invention relates to driver circuits applying sustain discharge voltage to X electrodes and Y electrodes.

### BACKGROUND ART

A flat display apparatus using a flat display panel has replaced a conventional cathode ray tube, and it has been put into practical use widely from small scale to large scale. In particular, in the large scale field, by taking advantage of properties on principle structure of a PDP, a commercialization thereof has been promoted as a mainstream of diffusion.

Also, for encouraging a further wide range of diffusion for the future, the cost reduction of the apparatus itself is desired.

FIG. 1 shows an entire configuration of a PDP apparatus of three-electrode-type AC surface discharge method. As shown in this figure, the PDP apparatus includes a plasma display panel 10 and driver circuits of a panel. The plasma display panel 10 has a plurality of X and Y electrodes which extend in a horizontal direction (first direction) and are arranged alternately next to each other and a plurality of address (A) electrodes which extend in a longitudinal direction (second direction) and are arranged so as to intersect at right angles with the plurality of X and Y electrodes. A display cell is formed at an intersection between the address electrode and a pair of the X and Y electrodes.

The driver circuits include: an address-electrode driver circuit 11 which drives the plurality of address electrodes; a scanning circuit 12 which applies a scan pulse to the plurality of Y electrodes in order and also applies a sustain discharge voltage and an auxiliary voltage thereto; a Y-electrode driver circuit 13 which supplies the sustain discharge voltage and the auxiliary voltage to the scanning circuit 12; an X-electrode driver circuit 14 which applies the sustain discharge voltage to the plurality of X electrodes; a driving control circuit 15 which controls each of the circuits described above; a signal processing circuit 16 which processes a display signal inputted from external and supplies the same to the driving control circuit 15; and an AC/DC power supply circuit 17 which converts AC power supplied from external into DC power to generate a power supply voltage supplied to respective units.

FIG. 2 shows basic driving waveforms applied to each of the electrodes for performing image display as an operation of the driver circuits of FIG. 1. Here, a reference potential is GND (0 V), and unless otherwise stated particularly, the reference potential is applied to each of the electrodes.

A driving period of the PDP includes a reset (R) period, an address (A) period, and a sustain (SUS) period. In the reset period, a reset voltage Vw of high voltage (about 400 V) is applied to the plurality of Y electrodes at the same time to generate discharges at all the display cells, thereby performing the initialization to put the display cells into the same state. Here, a reset pulse RP of a slope waveform in which a voltage value is gradually increased to the reset voltage Vw is applied to the Y electrodes. However, there are various types of modified examples for the applied waveforms, and the reset pulse is applied to the X electrode and the reset pulse is applied to both the X and Y electrodes in other modified examples.

In the address period, a scan pulse SP of a scan voltage −Vy is sequentially applied to the Y electrodes Y1 to Yn serving as scan electrodes, and an address pulse AP of a voltage Va is applied to the address electrode of the display cell to be lit in synchronization with the application of the scan pulse, thereby generating an address discharge at the display cells to be lit to store a wall charge.

In the sustain period, by alternately applying sustain pulses YSUS and XSUS of a sustain voltage Vs to all of the Y and X electrodes, the sustain discharge is generated at the display cells in which the wall charge is stored by the address discharge in the previous address period, and the sustain discharge is repeated by the application of the sustain pulse.

It is also possible to perform a shading grayscale display by combining a series of the basic operations of the driving waveforms as shown in FIG. 2 to control the number of times of light emission by the sustain discharge, and a grayscale display method by sub-frame method is adopted widely at present.

Since a configuration and an operation of a PDP apparatus are known widely, more description thereof is omitted, and the Y-electrode driver circuit 13 and the X-electrode driver circuit 14 related to the present invention will be further described.

FIG. 3 is a diagram showing a configuration example of a conventional Y-electrode driver circuit 13. As shown in this figure, the Y-electrode driver circuit 13 includes a sustain-voltage generating circuit 21, an auxiliary voltage circuit 22, and an A/S separating circuit 23. The sustain-voltage generating circuit 21 has switch elements Q1 and Q2 which are connected in series between a voltage source of the sustain voltage Vs (about 200 V) and the reference potential source (GND). A connection node of Q1 and Q2 is connected to the A/S separating circuit 23. The switch elements Q1 and Q2 are N-type MOSFETs. The N-type MOSFET has a built-in diode which is connected to FET in parallel. Control signals CU and CD are inputted to trigger electrodes of the switch elements Q1 and Q2, respectively.

The auxiliary voltage circuit 22 includes a switch element Q5, resistors R1 and R2, and a switch element Q6 which are connected in series between a voltage source of the reset voltage Vw (about 400 V) and a voltage source of the scan voltage −Vy (−100 V). A connection node of the resistors R1 and R2 is connected to the A/S separating circuit 23 and the scanning circuit 12. The switch elements Q5 and Q6 are N-type MOSFETs. Control signals Pw and Scn are inputted to trigger electrodes of the switch elements Q5 and Q6, respectively.

The A/S separating circuit 23 includes switch elements Q3 and Q4 of N-type MOSFETs connected in series so that built-in diodes thereof are reversed in direction. A common separating signal A/S is inputted to trigger electrodes of the switch elements Q3 and Q4.

FIG. 4 is a diagram showing a configuration example of an individual scanning circuit 18 which constitutes the scanning circuit 12. As shown in this figure, the individual scanning circuit 18 includes: switch elements Q7 and Q8 which are connected in series between the reference power supply (GND) and an output terminal OUT of the Y-electrode driver circuit 13 and can operate at high speed; and two diodes D1 and D2 which are connected between the output terminal OUT and a connection node of Q7 and Q8 in the manner as shown in this figure. The diode D1 is connected to an output terminal SW1 through the switch SW1. The SW1 is turned off (in non-conductive state) only in the address period, and is turned on (in conductive state) in the reset period and the sustain period. The connection node of Q7 and Q8 is connected to each of the Y electrodes. Scan signals YS and /YS are inputted to trigger electrodes of Q7 and Q8, respectively. The scanning circuit 12 is configured of a plurality of the individual scanning circuits 18 corresponding to the number of the Y electrodes. The plurality of individual scanning circuits 18 are integrated on one chip or a plurality of chips.

The X-electrode driver circuit 14 is configured of the circuits having the same configuration as those of the sustain-voltage generating circuit 21 in the case of using the driving waveforms of FIG. 2. Note that, when an auxiliary voltage such as the reset pulse is applied to the X electrode, a configuration having an auxiliary voltage circuit and an A/S separating circuit is used as the same with the Y-electrode driver circuit 13.

FIG. 5 is a time chart showing the change of each of the control signals in the Y-electrode driver circuit 13 when the driving waveforms shown in FIG. 2 are applied.

In the reset period, the A/S is turned to “low (L)” and the A/S separating circuit 23 is put into an off state, and then, the Pw is turned to “high (H)” so that Vw is supplied to the output terminal OUT. Since the resistor R1 is provided, a voltage of the output terminal OUT is gradually increased to Vw as shown in this figure. At this time, all of CU, CD, Scn, YS, and /YS are at L, and SW1 is in an on state, and all of the outputs of the X-electrode driver circuit 14 and the address-electrode driver circuit 11 are at GND. When the output terminal OUT is increased so as to reach the reset voltage Vw, the reset voltage Vw is applied to each of the Y electrodes through the diode D2.

When the Pw is changed to L just before finishing the reset period and the address period is started, the Sch is changed to H, and a voltage of the output terminal OUT is gradually changed to −Vy. Also, the switch SW1 is turned off. When the voltage of the output terminal OUT is equal to or lower than GND, all of YS are turned to H, the Q7 is turned on, and each of the Y electrodes is turned to GND. When the voltage of the output terminal OUT is turned to −Vy, a scan pulse is sequentially applied to the YS and /YS. More particularly, a scan pulse by which the YS is turned to L and the /YS is turned to H is sequentially applied. By this means, the Q7 is turned off and the Q8 is turned on. Before applying the scan pulse and after finishing applying the scan pulse, the YS is turned back to H and the /YS is turned back to L, so that the Q7 is turned on and the Q8 is turned off. In this manner, the scan pulse is sequentially applied to the plurality of Y electrodes.

When the address period is finished, the Scn is changed to L, and the sustain period is started. At this time, all of the Y electrodes are at GND. In the sustain period, the SW1 is turned on and the A/S is changed to H. Then, when the CU is changed to H and the CD is changed to L, the Q1 is turned on and the Q2 is turned off, so that the output terminal OUT is changed to Vs and the Y electrode is changed to Vs. In other words, the sustain pulse is applied to the Y electrode. Further, when the CU is changed to L and the CD is changed to H, the Q1 is turned off and the Q2 is turned on, so that the output terminal OUT is changed to GND. On the other hand, the sustain pulse is applied to the X electrode from the X-electrode driver circuit 14.

A driver circuit of a PDP apparatus mentioned in the foregoing is disclosed in Patent document 1 (Japanese Patent Application Laid-Open Publication No. 9-97034), Patent document 2 (Japanese Patent Application Laid-Open Publication No. 2003-15600) and others and is known widely. Therefore, more description thereof is omitted here.

In FIG. 3, when the reset voltage Vw is outputted to the output terminal OUT, if the A/S separating circuit 23 is not provided, a reset voltage Vw (400 V) higher than Vs (200 V) is applied to the terminal of Q1. Therefore, current flows in from the Vw voltage source to the Vs voltage source through Q5, R1 and the built-in diode of Q1. In addition, when the scan voltage −Vy is outputted to the output terminal OUT, if the A/S separating circuit 23 is not provided, a scan voltage −Vy (−100 V) lower than the reference voltage (GND) is applied to the terminal of Q2. Therefore, a current flows in from the reference potential source (GND) to the −Vy voltage source through Q6, R2 and the built-in diode of Q2. The A/S separating circuit 23 is provided for preventing such an inflow of the current.

Patent document 1: Japanese Patent Application Laid-Open Publication No. 9-97034

Patent document 2: Japanese Patent Application Laid-Open Publication No. 2003-15600

### DISCLOSURE OF THE INVENTION

The A/S separating circuit prevents the inflow of the current from the auxiliary voltage circuit 22 to the sustain-voltage generating circuit 21 as described above. However, it is turned on in the sustain period by changing the A/S signal to H. In this state, the current flowing out from the Vs voltage source to the output terminal OUT when the Q1 is turned on and the current flowing in from the output terminal OUT to the reference potential source when the Q2 is turned on pass alternately with each other, which is a major cause of a loss by heat generation.

In addition, for the switch elements Q3 and Q4 which constitute the A/S separating circuit, a breakdown voltage against the voltage outputted from the auxiliary voltage circuit 22 is required. Further, the switch elements Q3 and Q4 are required to have low on-resistance in order to reduce the resistance against the sustain current. A switch element which meets such a requirement is expensive and becomes a cause of increasing a manufacturing cost.

An object of the present invention is to solve the problems described above.

In order to realize the object described above, in a plasma display apparatus of the present invention, the switch elements Q1 and Q2 are or one of them is replaced with a bidirectional switch, and the A/S separating circuit is removed.

More specifically, a plasma display apparatus of the present invention comprises: a plasma display panel including a plurality of X electrodes which extend in a first direction, a plurality of Y electrodes which extend in the first direction and are arranged next to the X electrodes, and a plurality of address electrodes which extend in a second direction substantially perpendicular to the first direction; an X-electrode driver circuit which drives the plurality of X electrodes; a Y-electrode driver circuit which drives the plurality of Y electrodes; and an address-electrode driver circuit which drives the plurality of address electrodes, wherein a sustain discharge voltage is applied alternately between the plurality of X electrodes and the plurality of Y electrodes, an auxiliary voltage other than the sustain discharge voltage is applied to at least either the plurality of X electrodes or the plurality of Y electrodes, at least either the X-electrode driver circuit or the Y-electrode driver circuit which drives an electrode to which the auxiliary voltage is applied includes a sustain-discharge voltage generating circuit which outputs a high side voltage and a low side voltage of the sustain discharge voltage to an output portion and an auxiliary-voltage generating circuit which outputs the auxiliary voltage, the sustain-discharge voltage generating circuit includes a first switch circuit which connects a high side voltage source of the sustain discharge voltage and the output portion and a second switch circuit which connects a low side voltage source of the sustain discharge voltage and the output portion, and at least either the first switch circuit or the second switch circuit is configured of a bidirectional switch in which two switch elements each composed of a switch and a diode connected in parallel to the switch are connected in series.

The first switch circuit is configured of the bidirectional switch when the auxiliary-voltage generating circuit outputs a voltage higher than the high side voltage of the sustain discharge voltage, and the second switch circuit is configured of the bidirectional switch when the auxiliary-voltage generating circuit outputs a voltage lower than the low side voltage of the sustain discharge voltage. Therefore, both of the first and second switch circuits are configured of bidirectional switches when the auxiliary-voltage generating circuit outputs a voltage higher than the high side voltage of the sustain discharge voltage and a voltage lower than the low side voltage of the sustain discharge voltage.

The bidirectional switch can be configured by connecting two N-type MOSFETs each having a built-in diode in series, connecting two P-type MOSFETs in series, connecting an N-type MOSFET and a P-type MOSFET in series, or connecting an element not having a built-in diode such as an IGBT, a bipolar transistor, a Bi-CMOSFET, a thyristor, TRIAC (registeredtrademark), a GTO, and a silicon carbide element and a diode in parallel.

In the present invention, one switch element with high breakdown voltage in a path in which sustain current flows can be removed, and further, a switch element with lower breakdown voltage can be used. By this means, current consumption and manufacturing cost can be reduced, and at the same time, a rising of current waveform applied to an electrode can be improved, so that display property of a plasma display apparatus can be improved.

### BRIEF DESCRIPTIONS OF THE DRAWINGS

FIG. 1 is a diagram showing an entire configuration of a conventional plasma display apparatus;

FIG. 2 is a driving waveform diagram of a plasma display apparatus;

FIG. 3 is a diagram showing a configuration of a conventional Y-electrode driver circuit;

FIG. 4 is a diagram showing a configuration example of a scanning circuit;

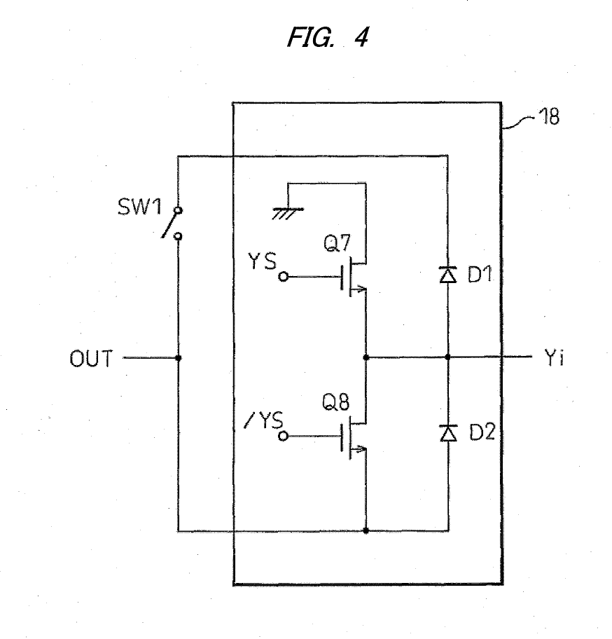

FIG. 5 is a time chart showing a change of a control signal in a Y-electrode driver circuit;

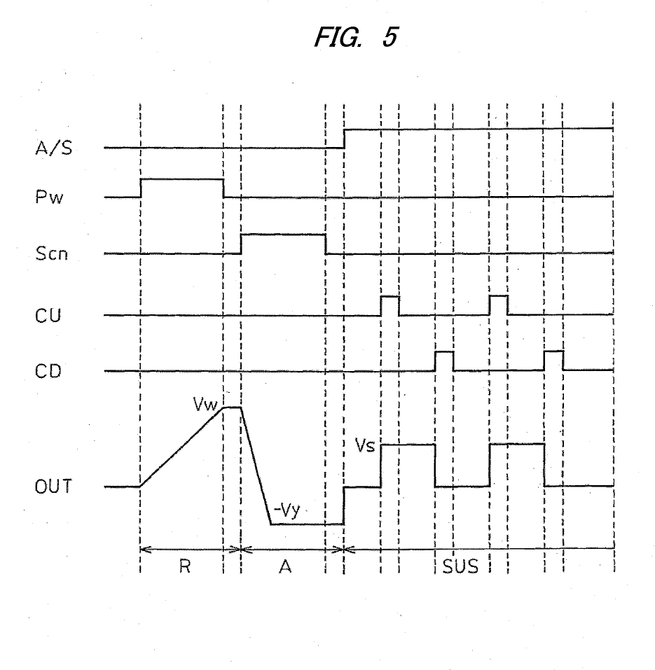

FIG. 6 is a diagram showing an entire configuration of a plasma display apparatus according to a first embodiment of the present invention;

FIG. 7 is a diagram showing a configuration of a Y-electrode driver circuit according to the first embodiment;

FIG. 8 is a diagram showing a configuration of a Y-electrode driver circuit according to a second embodiment;

FIG. 9 is a diagram showing a configuration of a Y-electrode driver circuit according to a third embodiment; and

FIG. 10 is a diagram showing a configuration of a Y-electrode driver circuit according to a fourth embodiment.

### BEST MODE FOR CARRYING OUT THE INVENTION

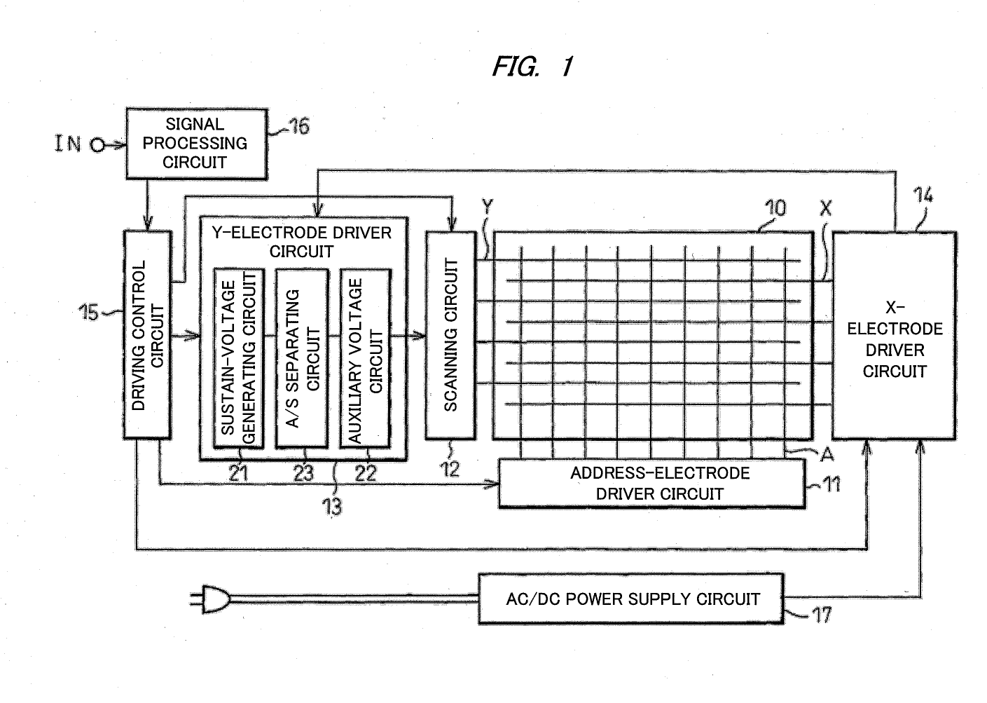

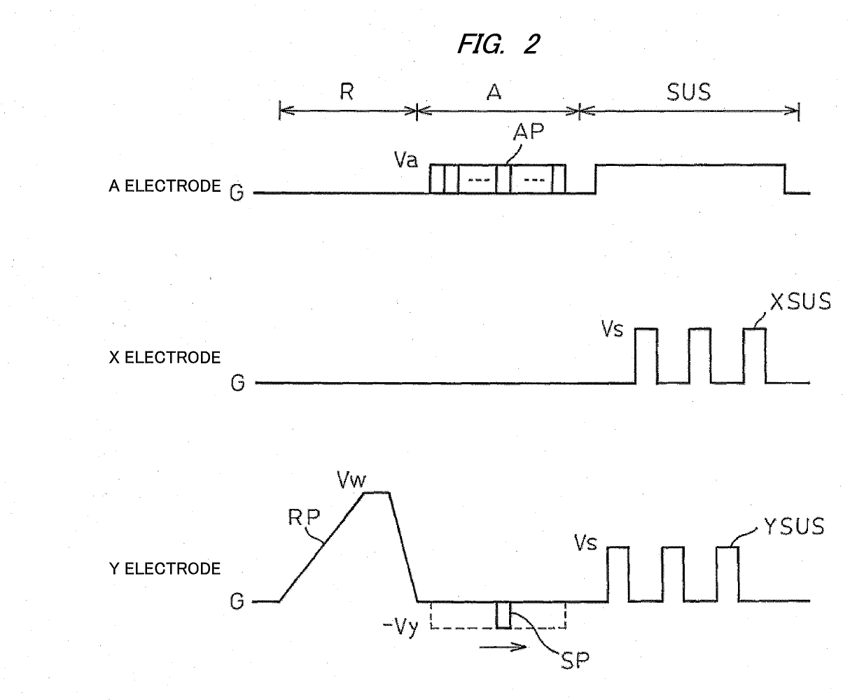

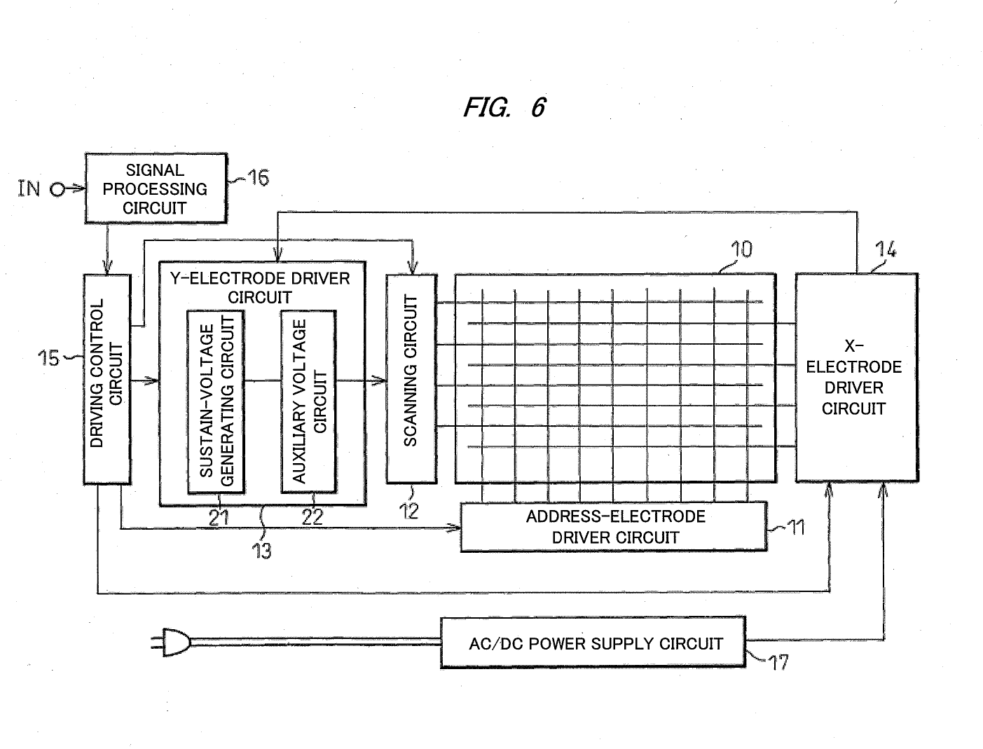

FIG. 6 is a diagram showing an entire configuration of a plasma display apparatus (PDP apparatus) according to a first embodiment of the present invention. In the PDP apparatus according to the first embodiment, the A/S separating circuit 23 in the Y-electrode driver circuit 13 of a conventional PDP apparatus shown in FIG. 1 is removed and a configuration of the sustain-voltage generating circuit 21 is modified, and the other parts of the PDP apparatus are the same as the conventional example. In addition, the waveforms as shown in FIG. 2 are applied to each of the electrodes.

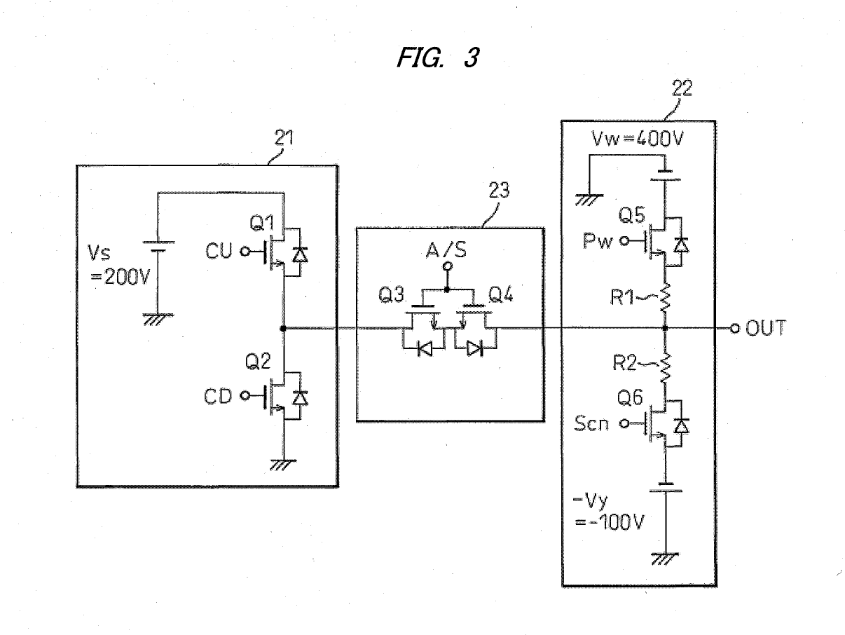

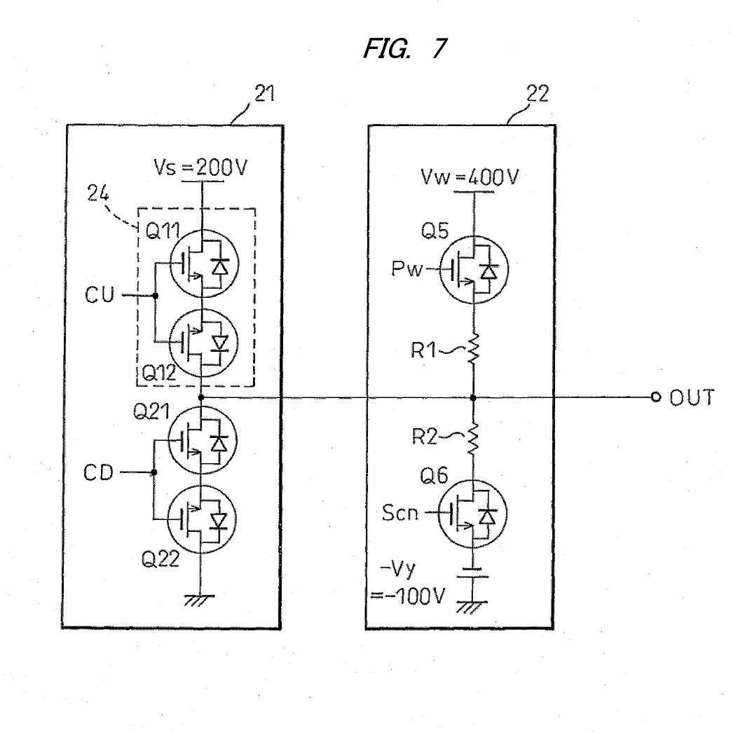

FIG. 7 is a diagram showing a configuration of the Y-electrode driver circuit 13 of the PDP apparatus according to the first embodiment. As shown in this figure, the auxiliary voltage circuit 22 has the same configuration as that of the conventional example. In the sustain-voltage generating circuit 21, a bidirectional switch 24 in which switch elements Q11 and Q12 of N-type MOSFETs are connected in series so that built-in diodes thereof are reversed in direction is used instead of the Q1 of FIG. 3. Similarly, a bidirectional switch in which switch elements Q21 and Q22 of N-type MOSFETs are connected in series so that built-in diodes thereof are reversed in direction is used instead of the Q2 of FIG. 3.

Because of the bidirectional switch, the inflow of the current from a Vw voltage source to a Vs voltage source and the inflow of the current from a reference potential source (GND) to a −Vy voltage source can be prevented.

Here, the comparison with the circuit of FIG. 3 will be made. In the conventional circuit of FIG. 3, in the case of Vs=200 V, Vw=400 V and −Vy=−100 V, since 200 V is applied to both ends of the Q1 and Q2 when one of them is turned on, a breakdown voltage (Vds) thereof is required to be 200 V or higher. Since 200 V is sometimes applied to the both ends of the Q3 when the A/S is H and the Q1 is turned on, the Vds is required to be 200 V or higher. Since the Vw (400 V) is sometimes applied to the both ends of the Q4 when the Q5 is turned on, the Vds is required to be 400 V or higher. The Vw+Vy (400 V+100 V=500 V) is sometimes applied to the both ends of the Q5 and Q6, the Vds is required to be 500 V or higher.

When a sustain voltage is outputted in the sustain discharge period, the Q3 and Q4 are turned on, and the CU is changed to H, so that a current is supplied from the Vs voltage source to a panel through channels of Q1 and Q3 and a channel and a body-diode of Q4. In other words, the sustain current passes through the Q1 (Vds=200 V or higher), Q3 (Vds=200 V or higher) and Q4 (Vds=400 V or higher).

Similarly, when an electrode is drawn into a reference voltage in the sustain discharge period, the Q3 and Q4 are turned on and the CD is changed to H, so that a current is supplied from the panel to the reference voltage source through the channel of Q4, the channel and a body-diode of Q3, and the channel of Q2. In other words, the sustain current passes through the Q4 (Vds=400 V or higher), Q3 (Vds=200 V or higher), and Q2 (Vds=200 V or higher).

On the other hand, in the first embodiment, since 200 V is sometimes applied to both ends of the Q11 when the CU is H, Vds=200 V or higher is required in the Q11. Since 400 V is sometimes applied to both ends of the Q12 when the Q5 is turned on, Vds=400 V or higher is required in the Q12. Since 400 V is sometimes applied to both ends of the Q21 when the Q5 is turned on, Vds=400 V or higher is required in the Q21. Since −Vy (−100 V) is applied to both ends of the Q22 when the Q6 is turned on, Vds=100 V or higher is required in the Q22. The Q5 and Q6 are the same as those of FIG. 3.

When a sustain voltage is outputted in the sustain discharge period, the CU is changed to H, so that a current is supplied from the Vs voltage source to the panel through a channel of the Q11 and a channel and a body-diode of the Q2. In other words, the sustain current passes through the Q11 (Vds=200 V or higher) and Q12 (Vds=400 V or higher).

Similarly, when an electrode is drawn into a reference voltage in the sustain discharge period, the CD is changed to H, so that a current is supplied from the panel to the reference voltage source through a channel of the Q21 and a channel and a body-diode of the Q22. In other words, the sustain current passes through the Q21 (Vds=400 V or higher) and Q22 (Vds=100 V or higher).

Therefore, in the first embodiment, in a path through which a sustain current when the sustain voltage is applied flows, one switch element with Vds=200 V or higher can be removed, compared with the conventional example of FIG. 3.

Further, in a path through which a sustain current when the sustain voltage is drawn in flows, one switch element with Vds=200 V or higher can be removed and one switch element can be replaced with an element with Vds=100 V or higher, compared with the conventional example of FIG. 3.

In a PDP apparatus according to a second embodiment of the present invention, a reset pulse RP is modified to be applied to an X electrode.

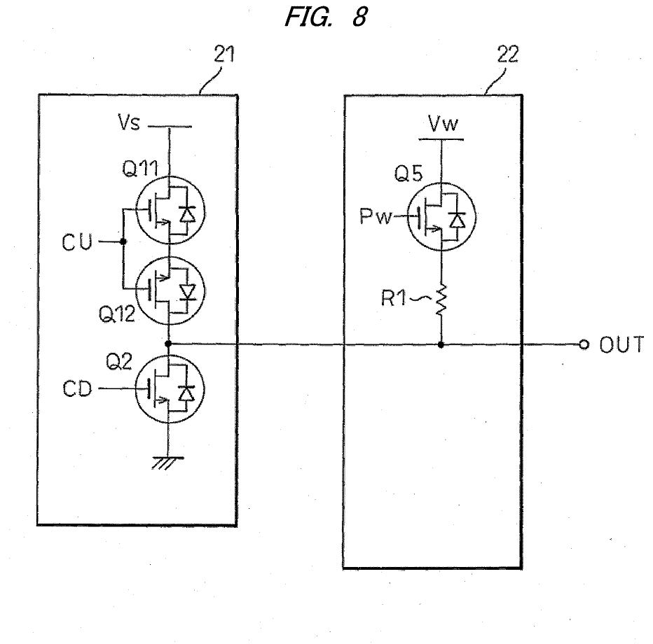

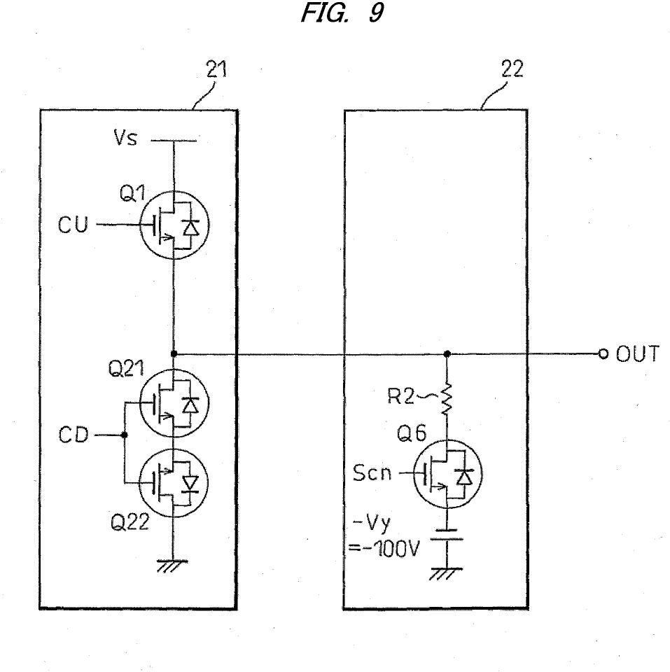

FIG. 8 shows a configuration of the X-electrode driver circuit 14 of a PDP apparatus according to a second embodiment, and FIG. 9 shows a configuration of the Y-electrode driver circuit 13 of the PDP apparatus according to the second embodiment. The X-electrode driver circuit 14 of the second embodiment includes the sustain-voltage generating circuit 21 and the auxiliary voltage circuit 22 which outputs a voltage Vw higher than the sustain discharge voltage Vs. The auxiliary voltage circuit 22 outputs the voltage Vw higher than the sustain discharge voltage Vs, but does not output a voltage lower than the reference potential GND. Therefore, as shown in FIG. 8, a bidirectional switch is not required to be used on a lower side (low side) of the sustain-voltage generating circuit 21, and the switch element Q2 is used as the same with FIG. 3.

As shown in FIG. 9, in the Y-electrode driver circuit 13 of the second embodiment, a portion which outputs Vw of the auxiliary voltage circuit 22 is removed in the first embodiment, and the Q1 similar to the conventional example of FIG. 3 is provided instead of the bidirectional switch 24 in the sustain-voltage generating circuit 21. Since the auxiliary voltage circuit 22 does not output a voltage higher than the sustain voltage Vs, no problem occurs even if the Q1 is provided.

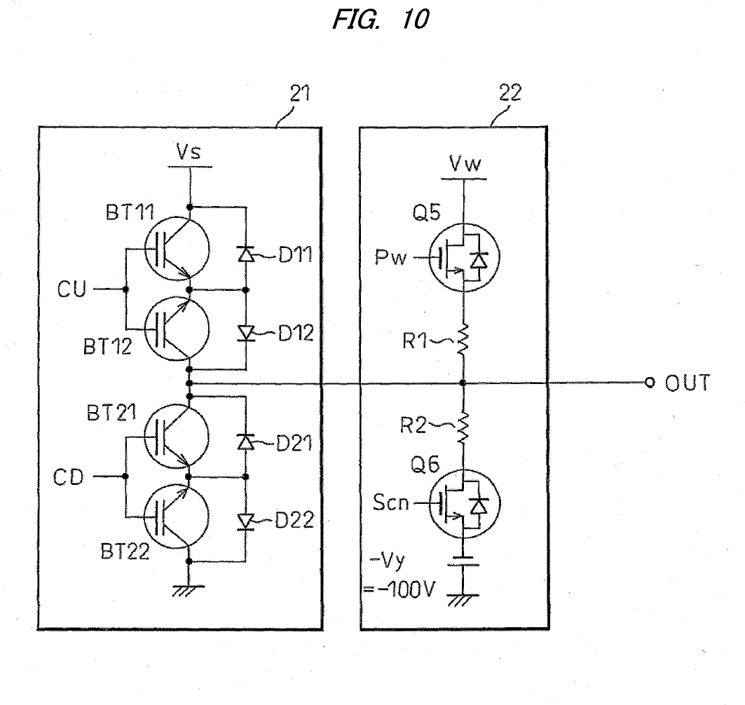

FIG. 10 is a diagram showing a configuration of the Y-electrode driver circuit 13 of a PDP apparatus according to a third embodiment of the present invention. In the Y-electrode driver circuit 13 of the third embodiment, insulated-gate bipolar transistors (IGBT) BT11, BT12, BT21 and BT22 are used instead of N-type MOSFETs Q11, Q12, Q21 and Q22 in the first embodiment. Since the IGBT does not have a built-in diode, diodes D11, D12, D21 and D22 having the direction as shown in this figure and connected in parallel to each of the IGBTs are provided as shown in this figure. This is because, since a breakdown voltage in a reverse direction of an IGBT is not so high and there is a possibility that it is broken when a reverse voltage is applied thereto, the breakage has to be prevented. Since an operation and others are the same as those of the first embodiment, the description thereof is omitted.

Note that a bipolar transistor, a Bi-CMOSFET, a thyristor, TRIAC (registered trademark), a GTO, a silicon carbide (SiC) element, and others can be used instead of the IGBT, and since these elements do not have a built-in diode, the diode is connected in parallel thereto.

In the foregoing, the present invention has been described based on the embodiments. However, various modifications thereof can be made therein. For example, a voltage applied to each of electrodes is arbitrarily determined, and a configuration of the driver circuit is appropriately determined in accordance with it.

1. A plasma display apparatus comprising:
a plasma display panel including a plurality of X electrodes which extend in a first direction, a plurality of Y electrodes which extend in the first direction and are arranged next to the X electrodes, and a plurality of address electrodes which extend in a second direction substantially perpendicular to the first direction;
an X-electrode driver circuit which drives the plurality of X electrodes;
a Y-electrode driver circuit which drives the plurality of Y electrodes; and
an address-electrode driver circuit which drives the plurality of address electrodes,
wherein a sustain discharge voltage is applied alternately between the plurality of X electrodes and the plurality of Y electrodes,
an auxiliary voltage other than the sustain discharge voltage is applied to at least either the plurality of X electrodes or the plurality of Y electrodes,
at least either the X-electrode driver circuit or the Y-electrode driver circuit which drives an electrode to which the auxiliary voltage is applied includes a sustain-discharge voltage generating circuit which outputs a high side voltage and a low side voltage of the sustain discharge voltage to an output portion and an auxiliary-voltage generating circuit which outputs the auxiliary voltage,
the sustain-discharge voltage generating circuit includes a first switch circuit which connects a high side voltage source of the sustain discharge voltage and the output portion and a second switch circuit which connects a low side voltage source of the sustain discharge voltage and the output portion, and
at least either the first switch circuit or the second switch circuit is configured of a bidirectional switch in which two switch elements each composed of a switch and a diode connected in parallel to the switch are connected in series.

2. The plasma display apparatus according to claim 1,
wherein the first switch circuit is configured of the bidirectional switch when the auxiliary-voltage generating circuit outputs a voltage higher than the high side voltage of the sustain discharge voltage.

3. The plasma display apparatus according to claim 1,
wherein the second switch circuit is configured of the bidirectional switch when the auxiliary-voltage generating circuit outputs a voltage lower than the low side voltage of the sustain discharge voltage.

4. The plasma display apparatus according to claim 1,
wherein the bidirectional switch is configured by connecting two N-type MOSFETs each having a build-in diode in series.

5. The plasma display apparatus according to claim 1,
wherein the bidirectional switch is configured by connecting two P-type MOSFETs each having a build-in diode in series.

6. The plasma display apparatus according to claim 1,
wherein the bidirectional switch is configured by connecting an N-type MOSFET having a built-in diode and a P-type MOSFET having a build-in diode in series.

7. The plasma display apparatus according to claim 1,
wherein the switch element is configured by connecting any one of an IGBT, a bipolar transistor, a Bi-CMOSFET, a thyristor, TRIAC (registered trademark), , a GTO, and a silicon carbide element and a diode in parallel.

8. The plasma display apparatus according to claim 1,
wherein the bidirectional switch is configured by connecting in series a switch element including an N-type MOSFET or a P-type MOSFET having a build-in diode and a switch element configured by connecting any one of an IGBT, a bipolar transistor, a Bi-CMOSFET, a thyristor, TRIAC (registeredtrademark), a GTO and a silicon carbide element and a diode in parallel.

9. A plasma display apparatus comprising:
a plasma display panel including a plurality of X electrodes which extend in a first direction, a plurality of Y electrodes which extend in the first direction and are arranged next to the X electrodes, and a plurality of address electrodes which extend in a second direction substantially perpendicular to the first direction;
an X-electrode driver circuit which drives the plurality of X electrodes;
a Y-electrode driver circuit which drives the plurality of Y electrodes; and
an address-electrode driver circuit which drives the plurality of address electrodes,
wherein a sustain discharge voltage is applied alternately between the plurality of X electrodes and the plurality of Y electrodes,
an auxiliary voltage other than the sustain discharge voltage is applied to at least either the plurality of X electrodes or the plurality of Y electrodes,
at least either the X-electrode driver circuit or the Y-electrode driver circuit which drives an electrode to which the auxiliary voltage is applied includes a sustain-discharge voltage generating circuit which outputs a high side voltage and a low side voltage of the sustain discharge voltage to an output portion and an auxiliary-voltage generating circuit which outputs the auxiliary voltage,
the sustain-discharge voltage generating circuit includes a first switch circuit which connects a high side voltage source of the sustain discharge voltage and the output portion and a second switch circuit which connects a low side voltage source of the sustain discharge voltage and the output portion, and
at least either the first switch circuit or the second switch circuit is configured of a bidirectional switch in which two MOSFETs each having a build-in diode are connected in series.

10. The plasma display apparatus according to claim 9,
wherein the first switch circuit is configured of the bidirectional switch when the auxiliary-voltage generating circuit outputs a voltage higher than the high side voltage of the sustain discharge voltage.

11. The plasma display apparatus according to claim 9,
wherein the second switch circuit is configured of the bidirectional switch when the auxiliary-voltage generating circuit outputs a voltage lower than the low side voltage of the sustain discharge voltage.

12. The plasma display apparatus according to claim 9,
wherein the bidirectional switch is configured by connecting two N-type MOSFETs in series.

13. The plasma display apparatus according to claim 9,
wherein the bidirectional switch is configured by connecting two P-type MOSFETs in series.

14. The plasma display apparatus according to claim 9,
wherein the bidirectional switch is configured by connecting of an N-type MOSFET and a P-type MOSFET in series.
